(19) United States
(12) Patent Application Publication
(10) Pub. No.: US 2023/0340182 A1
(43) Pub. Date: Oct. 26, 2023

(54) CONDUCTIVE POLYURETHANE

(71) Applicant: RAMPF HOLDING GMBH & CO. KG, Grafenberg (DE)

(72) Inventors: Andreas EISELE, Ausgburg (DE); Ramona STUMM, Eningen u.A. (DE)

(73) Assignee: RAMPF HOLDING GMBH & CO. KG, Grafenberg (DE)

(21) Appl. No.: 17/908,443

(22) PCT Filed: Mar. 30, 2021
(86) PCT No.: PCT/EP2021/058227

§ 371 Date: Aug. 31, 2022

(30) Foreign Application Priority Data
Apr. 1, 2020 (DE) 10 2020 204 215.2

(51) Int. Cl. C08G 18/42; C08G 18/36; C08G 18/66; C08G 18/76; C08K 3/04; C08K 3/36

(52) U.S. Cl. CPC C08G 18/4241; C08G 18/36; C08G 18/4288; C08G 18/6662; C08G 18/7664; C08K 3/041; C08K 3/36; C08K 2003/265

(57) ABSTRACT

The present invention is directed to a polyol composition comprising carbon nanotubes and at least one carbon particle, polyurethane systems comprising said polyol composition, and polyurethanes, their preparation and use, in particular for filter casting. Also disclosed is a process for preparing a polyurethane such as by mixing a polyol composition and at least one polyisocyanate.

The present invention is directed to a polyol composition comprising carbon nanotubes and at least one carbon particle, polyurethane systems comprising said polyol composition, as well as polyurethanes, their preparation and use, in particular for filter casting.

Polyurethanes are reaction products of polyols with polyisocyanates. Due to their variable product properties, polyurethanes are used in a wide variety of applications, e.g. as casting compounds, adhesives, flexible foams, rigid foams, elastomers, etc.

Polyurethane elastomers are used in large quantities in shoe soles, for example. Ideally, shoe soles are antistatic, i.e. conductive to a certain extent, in order to prevent electrical charging and thus increase wearing comfort. However, the conductivity of products can also have a safety-relevant aspect, for example in work shoes, to prevent electrostatic discharges, for example in potentially explosive environments.

Conductivity is achieved, for example, by adding electrically conductive fillers. To ensure matrix conductivity of the plastic material, the filler must be used in concentrations above the perculation limit. Such high filler contents, however, lead to a considerable increase in the viscosity of the polymer material, which makes processing much more difficult, if not impossible.

JP 2018-039959 discloses electrically conductive adhesive compositions of thermoplastics and thermosets with inorganic conductive filler particles. To ensure sufficient electrical conductivity, a filler content of 10-30 wt. % is suggested.

WO 01/23466 discloses epoxy-modified polyurethane resins with a conductive filler, in particular metal flakes. The sharp-edged filler particles have extremely abrasive properties and cannot be processed economically in commercial mixers. In addition, polymers filled in this way tend to corrode.

KR 20030063246 discloses adhesives for laying floor coverings. The antistatic properties are achieved by adding significant amounts of carbon black.

EP 0 786 422 discloses electrically conductive polyurethane films for the production of flexible inserts for containers for storing flammable liquids. The electrostatic equipment of the thermoplastic polyurethane material is achieved by high concentrations of carbon black with a high specific surface area.

The antistatic polyurethanes known from the prior art are hardly processable in commercially available mixing units either because of the filler properties or the high matrix viscosity, or they do not have the required conductivities. In addition, in adhesive applications, a low viscosity of the adhesive is essential for easy dispensing and good contacting of the substrates, in particular in complex structures (e.g. undercuts).

Therefore, the object of the present invention is to provide polyurethane systems which, on the one hand, exhibit high electrical conductivity and, at the same time, are easy to process and are particularly suitable for adhesive applications (e.g. filter casting).

Surprisingly, it was found that the combination of carbon nanotubes and carbon particles in a polyol results in high conductivity of the polyurethane product even at low filler contents. Accordingly, the polyol composition according to the present invention has a low viscosity and is easily processable in both dynamic and dynamic-static mixing systems. The polyurethanes obtained are characterized by good mechanical properties in terms of hardness, elongation at break, tensile strength, tear propagation resistance and impact strength.

In one aspect, therefore, the present invention relates to a polyol composition comprising.
(i) at least one polyol having a functionality of ≥2.2, preferably ≥2.8,
(ii) carbon nanotubes,
(iii) at least one carbon particle having a specific electrical resistance of ≥1Ω/cm measured according to IS 12178-1987 (Indian Standard), and
(iv) optionally, at least one filler.

Polyols are compounds having at least two OH groups, which are particularly reactive to isocyanates.

Component (i) defines the totality of all polyols with a functionality of ≥2.2, preferably ≥2.8.

A preferred polyol is a polyester polyol with an OH functionality of ≥2.2, preferably ≥2.8, or a polyether polyol with a functionality of ≥2.2, preferably ≥2.8, or castor oil or a castor oil derivative (e.g. Albodur 901, Albodur 903, Setathane 1150, Setathane 1160, Voranol RN490) with an OH functionality of ≥2.2, preferably ≥2.8.

In one embodiment, component (i) comprises at least two polyols each having a functionality of ≥2.2, preferably ≥2.8.

In a preferred embodiment, component (i) comprises at least one polyester polyol, castor oil, and optionally at least one polyether polyol each having a functionality of ≥2.2, preferably ≥2.8.

In a preferred embodiment, the polyol having a functionality of ≥2.2, preferably ≥2.8, in component (i) has an OH number of 120-800 mg KOH/g, preferably 140-500 mg, more preferably 140-450 mg KOH/g.

All polyols having a functionality of ≥2.2, preferably ≥2.8, form the component (i), which has an overall preferred functionality of 2.2-5.0, more preferably 2.2-4.0 and/or an OH number of 140-500 mg KOH/g, more preferably 140-450 mg KOH/g.

Component (i) has an overall preferred viscosity of 300-16,000 mPas, more preferably 300-2,000 mPas, more preferably 300-1,200 mPas, measured at 20° C. according to DIN EN 53019-1.

Component (i) preferably accounts for 40-99.7 wt. %, more preferably 50-99.7 wt. %, even more preferably 60-99.7 wt. % based on the polyol composition.

The polyol composition further comprises carbon nanotubes (component (ii)). Preferably, single-walled carbon nanotubes (SWCNTs) are used in the polyol composition. The carbon nanotubes preferably have an average outer diameter of 0.5-50 nm, more preferably 1.0-2.0 nm.

The carbon nanotubes (component (ii)) have an average length of 1-500 μm, preferably 1-50 μm. Preferably, the average aspect (length/external diameter) ratio of the carbon nanotubes is in the range of 20-1,000,000, more preferably 500-100,000.

The carbon nanotubes may be predispersed in a carrier material. Suitable carrier materials are, for example, fatty acid ester, fatty acid glycidyl ester, alkyl glycidyl ester, glycol ester, fatty acid carboxylate ester derivative, ethoxylated alcohol, distyryl biphenyl derivative, alkylene glycol, triethylene glycol dimethacrylate, polyolefin ammonium salt, or a mixture thereof. The predispersed carbon nanotubes are present, for example, at a concentration of 50-200 g/kg of carrier material. Suitable predispersed nanotubes are commercially sold, for example, by C. H. Erbslöh under the name Tuball Matrix 202.

The carbon nanotubes are preferably characterized by a specific electrical conductivity of 100-10,000 S/cm, more preferably 300-8,000 S/cm, measured according to DIN ES 12178-1987.

Component (ii) preferably accounts for 0.01-0.1 wt. %, more preferably 0.02-0.05 wt. %, based on the polyol composition.

The polyol composition comprises, as component (iii), at least one carbon particle having an electrical resistance of ≤1Ω/cm. Preferably, component (iii) comprises at least one conductive carbon black. Preferably, the carbon particles according to component (iii) are substantially amorphous, more preferably at least 95% amorphous.

Preferably, the carbon particles in component (iii) are obtained by combustion of acetylene in the presence of sub-stoichiometric amounts of oxygen. Suitable carbon particles are commercially available, for example, from Orion Engineered Carbons (e.g., Y50A).

The carbon particles preferably have a BET value of 5-300 m²/g, more preferably 20-200 m²/g according to ASTM D 6556. In a preferred embodiment, component (iii) accounts for 0.2-4 wt. %, more preferably 1.0-3.0 wt. % based on the polyol composition.

In a preferred embodiment, the weight ratio of component (ii) to component (iii) is 1:75-1:3, more preferably 1:50-1:10.

The polyol composition may further comprise at least one filler (component (iv)). Preferred fillers are selected from the group consisting of inorganic or organic fillers, in particular carbonates, such as calcium carbonate or magnesium carbonate, dolomite, Al(OH)₃ or Al₂O₃, SiO₂, barium sulfate, talc, zirconium oxide or mixtures thereof.

The total of the fillers (component (iv)) preferably accounts for 0-50 wt. %, more preferably 0.01-50 wt. %, even more preferably 0.01-35 wt. % based on the polyol composition.

The polyol composition according to the present invention may further contain
(v) at least one excipient; and
(vi) optionally, a water scavenger.

Suitable excipients are, for example, defoamers, such as Byk-A 535 or Byk 088, wetting and dispersing agents, such as Disperbyk 2157 or Byk 9076.

As water scavengers, zeolites and/or silica particles may be considered.

In a preferred embodiment, the polyol composition according to the present invention contains substantially no foaming agent, in particular substantially no water and substantially no hydrocarbon, e.g. pentane, cyclopentane, etc., or methylene chloride. The water content in the polyol composition according to the present invention is preferably 0.01-2 wt. %, more preferably <1.5 wt. %, based on the polyol composition. The hydrocarbon content in the polyol composition according to the invention is preferably 0.01-2 wt. %, more preferably <1.5 wt. %, based on the polyol composition.

Preferably, the excipients (v) are used in a total concentration of 0-5 wt. %, more preferably 0.001-5 wt. %, even more preferably 0.001-2.5 wt. %, based on the polyol composition. The water scavengers (vi) may preferably be present in the polyol composition in a total concentration of 0-10 wt. %, more preferably 0.1-10 wt. %, even more preferably 1-5 wt. %.

Preferably, the polyol composition of the present invention has a viscosity of 500-10,000 mPas, preferably 2,000-6,000 mPas at 20° C. measured according to DIN EN 53019-1.

The polyol composition according to the present invention is characterized by a high storage stability. Thus, in the polyol compositions according to the present invention, no phase separation is visible to the naked eye after 6 months, preferably after 12 months.

Another aspect of the present invention is a polyurethane system comprising
(a) a polyol composition according to the present invention; and
(b) at least one polyisocyanate.

Polyisocyanates are compounds having at least two NCO groups. Preferably, the polyisocyanate is selected from aromatic or aliphatic polyisocyanate, in particular monomeric MDI, oligomeric MDI or polymeric MDI, TDI, HDI, IPDI, H₁₂MDI or TMXDI.

The polyisocyanate preferably has an NCO content of ≥15%, more preferably ≥23%. Similarly, the overall NCO content of component (b) is preferably ≥15%, more preferably ≥23%, even more preferably ≥30%.

In the polyurethane system, the molar ratio of isocyanate-reactive groups (e.g. —OH, —NH₂ or —SH) to isocyanate groups is preferably 1.0-1.1:1.1-1.0, more preferably substantially 1:1.

The viscosity of component (b) is overall preferably 10-5,500 mPas, more preferably 20-1,000 mPas at 20° C. measured according to DIN EN 53019-1.

In another aspect, the present invention relates to a process for preparing a polyurethane comprising the steps of
(I) providing a polyol composition of the present invention,
(II) providing at least one polyisocyanate as described above,
(III) mixing the polyol composition and at least one polyisocyanate optionally by adding a catalyst and optionally at elevated temperature.

Furthermore, the present invention relates to a polyurethane which can be obtained by the process described above.

Surprisingly, it has been shown that a functionality of >2 in the polyol leads to a higher conductivity of the polyurethane prepared with the polyol composition than when using lower functional polyols.

Preferably, the polyurethane system or polyurethane according to the present invention is a cast elastomer. Preferably, the polyurethane system or polyurethane according to the present invention is not a foam. Preferably, the polyurethane system or polyurethane of the present invention has a porosity of <2%, more preferably 0.001-1.5%, measured from the ratio of the density of the foamed material to the solid, the density being determined according to ASTM D792.

Preferably, the polyurethane of the present invention has a surface resistivity of 0.05-0.5 M Ω/cm measured according to IEC 62631-3-2 and/or a volume resistivity of 0.005-0.5 M Ω/cm measured according to ASTM D 991/ISO1853.

Preferably, the polyurethane of the present invention has a hardness in the range of Shore A 40-Shore D 85.

It has been found that the polyurethane systems of the present invention are easy to process and self-levelling due to their low viscosity. The polyurethanes produced therefrom have good mechanical and electrical properties. In addition, the polyurethanes have been shown to have good compatibility with other substrates, such as metal, polystyrene, SAN, PA, polyolefin, e.g., PE, PP, and ABS.

Thus, another aspect of the present invention is the use of the polyol composition according to the present invention, the polyurethane system according to the present invention, and the polyurethane according to the present invention as an adhesive and sealant, in particular for bonding filters into a corresponding filter housing (filter casting).

Surprisingly, it has been shown that the combination of carbon nanotubes and carbon particles leads to high conductivities in the polymer matrix even at low concentrations. The low levels of conductive fillers allow the provision of low viscosity polyol compositions and polyurethane systems. The filler combination hardly affects the mechanical properties of the polyurethanes, so that no significant reduction of the Young's modulus or elongation at break is observed compared to the unfilled polyurethanes. The variable polyurethane systems can be tailored for the respective applications in terms of hardness, adhesion to substrates, speed of cure, etc.

Furthermore, the polyurethane system of the present invention can be processed without significant abrasion via conventional dynamic or static dynamic mixing systems.

The present invention is explained with reference to the following non-exhaustive examples:

### EXAMPLES

### Example 1

28.2 wt. % castor oil
30.8 wt. % glycerol started polyester polyol OHZ=400 mgKOH/g
0.5 wt. % dispersing additive
3.5 wt. % molecular sieve
0.5 wt. % nanotubes, predispersed
35 wt. % chalk
1.5 wt. % conductive carbon black, acetylene-based
Cured with Desmodur 44V20 LF in the mixing ratio of 100:41
Index: 102

### Physical Characteristics

Viscosity of polyol system (20° C.)=3900 mPas
Hardness: Shore-D=79
Specific surface resistivity: 0.07 M Ω/cm
Specific volume resistivity: 0.02 M Ω/cm

### Example 2

39.6 wt. % castor oil
29.4 wt. % castor oil-based polyester polyol with OHZ=160 mgKOH/g
0.5 wt. % dispersing additive
3.5 wt. % molecular sieve
0.5 wt. % nanotubes, predispersed
25 wt. % chalk
1.5 wt. % conductive carbon black, acetylene-based
Cured with Desmodur 44V20 LF in the mixing ratio of 100:27
Index: 100

### Physical Characteristics

Viscosity of polyol system (20° C.)=4300 mPas
Hardness: Shore A=80
Specific surface resistivity 0.4 M Ω/cm
Specific volume resistivity: 0.2 M Ω/cm

### Comparative Example 1

19.5 wt. % castor oil
51 wt. % castor oil-based polyester polyol with OHZ=185 mgKOH/g
1.0 wt. % dispersing additive
3.0 wt. % molecular sieve
0.5 wt. % nanotubes, predispersed
25 wt. % chalk
Cured with Desmodur 44V20 LF in the mixing ratio: 100:31
Index: 102
Viscosity of polyol system (20° C.)=2230 mPas
Specific surface resistivity: >50 G Ω/cm
Specific volume resistivity: >50 G Ω/cm

### Comparative Example 2

39.5 wt. % castor oil
24.5 wt. % expoxidized soybean oil based polyester polyol OHZ=80 mgKOH/g
1.0 wt. % dispersing additive
3.0 wt. % molecular sieve
5 wt. % 1,4-butanediol
0.5 wt. % nanotubes, predispersed
25 wt. % chalk
1.5 wt. % carbon black, non-acetylene based
Cured with Desmodur 44V20 LF in the mixing ratio: 100:36
Index: 102
Viscosity of the polyol system (20° C.) =2070 mPas
Specific volume resistivity: 59 M Ω/cm

The following items are comprised by the present invention:

1. A polyol composition comprising.
(i) at least one polyol having a functionality of 2.2,
(ii) carbon nanotubes,
(iii) at least one carbon particle having a specific electrical resistance of ≤1Ω/cm measured according to IS 12178-1987 (Indian Standard), and
(iv) optionally, at least one filler.

2. The polyol composition of item 1, wherein component (i) comprises at least two polyols each having a functionality of 2.2.

3. The polyol composition according to item 1 or 2, wherein component (i) comprises a polyester polyol having a functionality of 2.2.

4. The polyol composition according to any one of the preceding items, wherein component (i) comprises a polyether polyol having a functionality of ≥2.2.

5. The polyol composition according to any one of the preceding items, wherein component (i) comprises castor oil or a castor oil derivative having a functionality of ≥2.2.

6. The polyol composition according to any one of the preceding items, wherein component (i) comprises at least one polyester polyol, castor oil, and optionally at least one polyether polyol, each having a functionality ≥2.2.

7. The polyol composition according to any one of the preceding items, wherein the polyol with a functionality of ≥2.2 in component (i) has an OH number of 120-800 mg KOH/g, preferably 140-500 mg KOH/g, more preferably 140-450 mg KOH/g.

8. The polyol composition according to any one of the preceding items, wherein component (i) has a total functionality of 2.2-5.0, preferably 2.2-4.0 and/or an OH number of 140-500 mg KOH/g, more preferably 140-450 mg KOH/g.

9. The polyol composition according to any one of the preceding items, wherein component (i) has a total viscosity of 300-16,000 mPas, preferably 300-2,000 mPas, more preferably 300-1,200 mPas at 20° C. measured according to DIN EN 53019-1.

10. The polyol composition according to any one of the preceding items, wherein component (i) accounts for 40-99.7 wt. %, based on the polyol composition.

11. The polyol composition according to any one of the preceding items, wherein the carbon nanotubes are single-walled carbon nanotubes (SWCNTs).

12. The polyol composition according to any one of the preceding items, wherein the carbon nanotubes have an average outer diameter of 0.5-50 nm, preferably 1.0-2.0 nm.

13. The polyol composition according to any one of the preceding items, wherein the carbon nanotubes have an average length of 1-500 μm, preferably 1-50 μm, and wherein the carbon nanotubes preferably have an average aspect ratio of 20-1,000,000.

14. The polyol composition according to any one of the preceding items, wherein the carbon nanotubes are dispersed in a carrier material.

15. The polyol composition according to item 14, wherein the carrier material comprises a fatty acid ester, a fatty acid glycidyl ester, an alkyl glycidyl ester, a glycol ester, a fatty acid carboxylate ester derivative, an ethoxylated alcohol, distyryl biphenyl derivative, alkylene glycol, triethylene glycol dimethacrylate, polyolefin ammonium salt, or a mixture thereof.

16. The polyol composition according to any one of the preceding items, wherein the carbon nanotubes have a specific electrical conductivity of 100-10,000 S/cm measured according to DIN ES 12178-1987 (Indian Standard).

17. The polyol composition according to any one of the preceding items, wherein component (ii) accounts for 0.01-0.1 wt. %, preferably 0.02-0.05 wt. %, based on the polyol composition.

18. The polyol composition according to any one of the preceding items, wherein the carbon particles are substantially amorphous.

19. The polyol composition according to any one of the preceding items, wherein the carbon particles are obtainable by combustion of acetylene in the presence of sub-stoichiometric amounts of oxygen.

20. The polyol composition according to any one of the preceding items, wherein the specific surface area of the carbon particles has a BET value of 5-300 m²/g, preferably 20-200 m²/g measured according to ASTM D 6556.

21. The polyol composition according to any one of the preceding items, wherein component (iii) constitutes 0.2-4 wt. %, preferably 1.0-3.0 wt. %, based on the polyol composition.

22. The polyol composition according to any one of the preceding items, wherein the weight ratio of components (ii):(iii) is 1:75-1:3.

23. The polyol composition according to any one of the preceding items, wherein the filler is selected from the group consisting of inorganic or organic fillers, in particular carbonates, such as calcium carbonate or magnesium carbonate, dolomite, Al(OH)₃ or Al₂O₃, SiO₂, barium sulfate, talc, zirconium oxide, or mixtures thereof.

24. The polyol composition according to any one of the preceding items, wherein component (iv) accounts for 0-50 wt. %, preferably 0.01-35 wt. %, based on the polyol composition.

25. The polyol composition according to any one of the preceding items, further comprising.
(v) at least one excipient, such as defoamers, wetting and dispersing agents; and
(vi) optionally, a water scavenger.

26. The polyol composition according to any one of the preceding items, wherein component (v) constitutes 0-5 wt. %, preferably 0.001-2.5 wt. %, based on the polyol compositions.

27. The polyol composition according to any one of the preceding items, wherein component (vi) constitutes 0.1-10 wt. %, preferably 1-5 wt. %, based on the polyol composition.

28. A polyurethane system comprising
(a) a polyol composition according to any one of items 1-27, and
(b) at least one polyisocyanate.

29. The polyurethane system according to item 28, wherein the polyisocyanate is selected from aromatic or aliphatic polyisocyanate, in particular MDI, oligomeric or polymeric MDI, TDI, HDI, IPDI, H₁₂MDI or TMXDI.

30. The polyurethane system according to item 28 or 29, wherein the polyisocyanate has an NCO content of ≥15%.

31. The polyurethane system according to any one of items 28-30, wherein the molar ratio of isocyanate-reactive groups (e.g. —OH; —NH₂ or —SH) to isocyanate groups is 1.0-1.1:1.1-1.0, preferably 1:1.

32. A process for preparing a polyurethane comprising the steps of:
(I) providing a polyol composition (a) according to any one of items 1-27,
(II) providing at least one polyisocyanate (b),
(III) mixing the polyol composition and the at least one polyisocyanate, optionally by adding a catalyst and optionally at elevated temperature.

33. A polyurethane obtainable by a process according to item 32.

34. The polyurethane according to item 32, wherein the surface resistivity is 0.05-0.5 M Ω/cm measured according to IEC 62631-3-2.

35. The polyurethane according to any one of items 33 or 34, wherein the volume resistivity is 0.005-0.5 M Ω/cm measured according to ASTM D991/ISO 1853.

36. The polyurethane according to any one of items 33-35, wherein the hardness is in the range of Shore A 40-Shore D 85.

37. The use of a polyol composition according to any one of items 1-27, a polyurethane system according to any one of items 28-31 or a polyurethane according to any one of items 33-36 as an adhesive, sealant, in particular for filter casting.

1. A polyol composition comprising:
(i) at least one polyol having a functionality of ≥2.2;
(ii) carbon nanotubes; and
(iii) at least one carbon particle having a specific electrical resistance of ≤1Ω/cm measured according to IS 12178-1987 (Indian Standard).

2. The polyol composition according to claim 1, wherein component (i) comprises at least one polyester polyol and castor oil.

3. The polyol composition according to claim 1, wherein component (i) accounts for 40-99.7 wt. % based on the polyol composition.

4. The polyol composition according to claim 1, wherein the carbon nanotubes are single-walled carbon nanotubes (SWCNTs) and have an average outer diameter of 0.5-50 nm.

5. The polyol composition according to claim 1, wherein component (ii) accounts for 0.01-0.1 wt. % based on the polyol composition.

6. The polyol composition according to claim 1, wherein the carbon particles are substantially amorphous and are obtainable by combustion of acetylene in the presence of sub-stoichiometric amounts of oxygen.

7. The polyol composition according to claim 1, wherein component (iii) accounts for 0.2-4 wt. % based on the polyol composition.

8. The polyol composition according to claim 1, wherein the weight ratio of components (ii):(iii) is 1:75-1:3.

9. The polyol composition according to claim 1, further comprising
at least one excipient.

10. A polyurethane system comprising:
(a) a polyol composition according to claim 1; and
(b) at least one polyisocyanate.

11. The polyurethane system according to claim 10, wherein the polyisocyanate is selected from aromatic or aliphatic polyisocyanate.

12. A process for preparing a polyurethane comprising the steps of:
(I) providing the polyol composition according to claim 1;
(II) providing at least one polyisocyanate; and
(III) mixing the polyol composition and the at least one polyisocyanate.

13. A polyurethane obtainable by a process according to claim 12.

14. (canceled)

15. The polyol composition of claim 1, further comprising at least one filler.

16. The polyol composition according to claim 2, wherein component (i) further comprises at least one polyether polyol each having a functionality ≥2.2.

17. The polyurethane system according to claim 11, wherein the polyisocyanate is selected from MDI, oligomeric or polymeric MDI, TDI, HDI, IPDI, H₁₂MDI or TMXDI and has an NCO content of ≥15%.

18. The process for preparing a polyurethane of claim 12, wherein the mixing is performed by adding a catalyst.

19. The process for preparing a polyurethane of claim 12, wherein the mixing is performed at an elevated temperature.

20. The polyol composition according to claim 9, wherein the at least one excipient comprises defoaming agents, wetting agents and dispersing agents and wherein the polyol composition further comprises a water scavenger.
